(19) United States
(12) Patent Application Publication
(10) Pub. No.: US 2026/0251818 A1
(43) Pub. Date: Aug. 27, 2026

(54) OPTICAL DEVICE

(71) Applicant: ELECTRONICS AND TELECOMMUNICATIONS RESEARCH INSTITUTE, Daejeon (KR)

(72) Inventors: Chi-Sun HWANG, Daejeon (KR); Yong Hae KIM, Daejeon (KR); Hyunsu CHO, Daejeon (KR)

(21) Appl. No.: 19/329,104

(22) Filed: Sep. 15, 2025

(30) Foreign Application Priority Data
Feb. 24, 2025 (KR) 10-2025-0023947

(51) Int. Cl. G02B 1/00; B82B 1/00

(52) U.S. Cl. CPC G02B 1/002; B82B 1/005; G02B 2207/101

(57) ABSTRACT

Provided is an optical device including an insulation layer, a plurality of nanopatterns disposed on the insulation layer and spaced apart from each other on the insulation layer, and a medium layer covering the nanopatterns, wherein the nanopatterns include first to third nanopatterns, the first to third nanopatterns respectively include first to third different widths in a first direction parallel to a top surface of the insulation layer, and a first distance between the first nanopattern and the second nanopattern is different from a second distance between the second nanopattern and the third nanopattern.

### CROSS-REFERENCE TO RELATED APPLICATION

This U.S. non-provisional patent application claims priority under 35 U.S.C. § 119 of Korean Patent Application No. 10-2025-0023947, filed on February 24, 2025, the entire contents of which are hereby incorporated by reference.

### BACKGROUND

The present disclosure herein relates to an optical device, and more particularly, to an optical device including a meta-structure.

A meta-material is an artificial material having a periodic arrangement of meta-atoms designed with metals or dielectric materials with a very small size smaller than the wavelength of light in order to implement characteristics that do not exist in the nature. The meta-material may be designed to cause light and sound waves to interact with each other in such a way that natural materials are unable to do, and may be applied to a new application field such as a transparent object, a high-performance lens, an efficient small antenna, or an ultra-sensitive detector. Recently, in consideration of the difficulty, utility, and the like of complex three-dimensional meta-material processes, metasurface structures made by arranging unit structures designed on a two-dimensional thin film through the physical principles have been studied.

### SUMMARY

The present disclosure provides an optical device with improved light-emission characteristics.

Issues to be addressed in the present disclosure are not limited to those described above and other issues unmentioned above will be clearly understood by those skilled in the art from the following description.

An embodiment of the inventive concept provides an optical device including an insulation layer; a plurality of nanopatterns disposed on the insulation layer and spaced apart from each other on the insulation layer; and a medium layer covering the nanopatterns, wherein the nanopatterns include first to third nanopatterns, the first to third nanopatterns respectively include first to third different widths in a first direction parallel to a top surface of the insulation layer, and a first distance between the first nanopattern and the second nanopattern is different from a second distance between the second nanopattern and the third nanopattern.

In an embodiment, in a plan view, distances and directions of the nanopatterns may be randomly arranged in a direction parallel to the top surface of the insulation layer.

In an embodiment, the nanopatterns may have the same thickness in a direction vertical to the top surface of the insulation layer, and aspect ratios of the nanopatterns may be about 3 to about 10.

In an embodiment, cross sections of the nanopatterns may have planar circular or planar elliptical shapes.

In an embodiment, the nanopatterns may include at least one of a metal including gold, silver, aluminum, titanium, or the like, semiconductor oxide, or semiconductor nitride.

In an embodiment, the first nanopattern may include a first sidewall and a second sidewall facing each other in the first direction, wherein the first side wall may form a first angle with the top surface of the insulation layer, the second side wall may form a second angle with the top surface of the insulation layer, the first angle may be an obtuse angle, and the second angle may be an acute angle.

In an embodiment, the second nanopattern may include a third sidewall and a fourth sidewall facing each other in the first direction, wherein the third side wall may form a third angle with the top surface of the insulation layer, the fourth side wall may form a fourth angle with the top surface of the insulation layer, the third angle may be the same as the first angle, and the fourth angle may be the same as the second angle.

In an embodiment, the second nanopattern may include a third sidewall and a fourth sidewall facing each other in the first direction, wherein the third side wall may form a third angle with the top surface of the insulation layer, the fourth side wall may form a fourth angle with the top surface of the insulation layer, and the third and fourth angles may be right angles, and wherein the third nanopattern may include a fifth sidewall and a sixth sidewall facing each other in the first direction, wherein the fifth side wall may form a fifth angle with the top surface of the insulation layer, the sixth side wall may form a sixth angle with the top surface of the insulation layer, the fifth angle may be an acute angle, and the sixth angle may be an obtuse angle.

In an embodiment, the first nanopattern may have a first thickness in a direction vertical to the top surface of the insulation layer, the second nanopattern may have a second thickness smaller than the first thickness, and the third nanopattern may have a third thickness larger than the first thickness.

In an embodiment, the medium layer may include at least one of a polymer, a dielectric, glass, or an air cavity.

In an embodiment of the inventive concept, an optical device includes: an insulation layer; a plurality of nanopatterns arranged on the insulation layer and spaced apart from each other on the insulation layer; and a medium layer covering the nanopatterns, wherein the nanopatterns includes first to third nanopatterns, and the first nanopattern includes a first sidewall and a second sidewall facing each other in a first direction parallel to a top surface of the insulation layer, wherein the first side wall forms a first angle with the top surface of the insulation layer, the second side wall forms a second angle with the top surface of the insulation layer, the first angle is an obtuse angle, and the second angle is an acute angle.

In an embodiment, the second nanopattern may include a third sidewall and a fourth sidewall facing each other in the first direction, wherein the third side wall may form a third angle with the top surface of the insulation layer, the fourth side wall may form a fourth angle with the top surface of the insulation layer, the third angle may be the same as the first angle, or be a right angle, and the fourth angle may be the same as the second angle, or be a right angle.

In an embodiment, the third nanopattern may include a fifth sidewall and a sixth sidewall facing each other in the first direction, wherein the fifth side wall may form a fifth angle with the top surface of the insulation layer, the sixth side wall may form a sixth angle with the top surface of the insulation layer, the fifth angle may be an acute angle, and the sixth angle may be an obtuse angle.

In an embodiment, cross sections of the nanopatterns may have planar circular, planar elliptical, planar triangular, or planar rectangular shapes.

In an embodiment, a first distance between the first nanopattern and the second nanopattern may be different from a second distance between the second nanopattern and the third nanopattern.

In an embodiment, the first to third nanopatterns may respectively include first to third different widths in the first direction.

In an embodiment, the optical device may further include a substrate under the insulation layer, wherein the substrate may include a plurality of pixel areas, and at least one of the nanopatterns may overlap each of two neighboring pixel areas.

In an embodiment of the inventive concept, an optical device includes: a substrate including a plurality of pixel areas; a metal layer on the substrate; an insulation layer on the metal layer; a plurality of nanopatterns arranged on the insulation layer and spaced apart from each other on the insulation layer; and a medium layer covering the nanopatterns, wherein at least one of the nanopatterns overlaps each of two neighboring pixel areas, and aspect ratios of the nanopatterns are about 3 to about 10.

In an embodiment, a center of a top surface and a center of a bottom surface of at least one of the nanopatterns may be offset in a first direction parallel to a top surface of the insulation layer.

In an embodiment, in a plan view, distances and directions between the nanopatterns may be randomly arranged in a direction parallel to the substrate, and the nanopatterns may have different widths respectively in a first direction parallel to a top surface of the insulation layer.

### BRIEF DESCRIPTION OF THE FIGURES

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIG. 1 is a plan view of an optical device according to embodiments of the inventive concept;

FIG. 2 is a cross-sectional view cut along line A-A’ of FIG. 1 according to embodiments of the inventive concept;

FIG. 3 is a perspective view of an optical device according to embodiments of the inventive concept;

FIG. 4 is a cross-sectional view cut along line A-A’ of FIG. 1 according to embodiments of the inventive concept;

FIG. 5 is a perspective view of an optical device according to embodiments of the inventive concept;

FIG. 6 is a cross-sectional view cut along line A-A’ of FIG. 1 according to embodiments of the inventive concept;

FIG. 7 is a cross-sectional view cut along line A-A’ of FIG. 1 according to embodiments of the inventive concept;

FIG. 8 is a plan view of an optical device according to embodiments of the inventive concept; and

FIGS. 9A and 9B are cross-sectional views showing a process for manufacturing the optical device of FIG. 2.

### DETAILED DESCRIPTION

Embodiments of the inventive concept will be described below in more detail with reference to the accompanying drawings. In the specification, each of the phrases such as “A or B”, “at least one of A and B”, “at least one of A or B”, “A, B, or C”, “at least one of A, B, and C”, and “at least one of A, B, or C” may include any one of the items listed together in the corresponding one of the phrases, or all possible combinations thereof. In the specification, terms indicating an order such as first and second are used to distinguish components performing the same/similar functions from each other, and the numbers may change depending on the order in which they are mentioned.

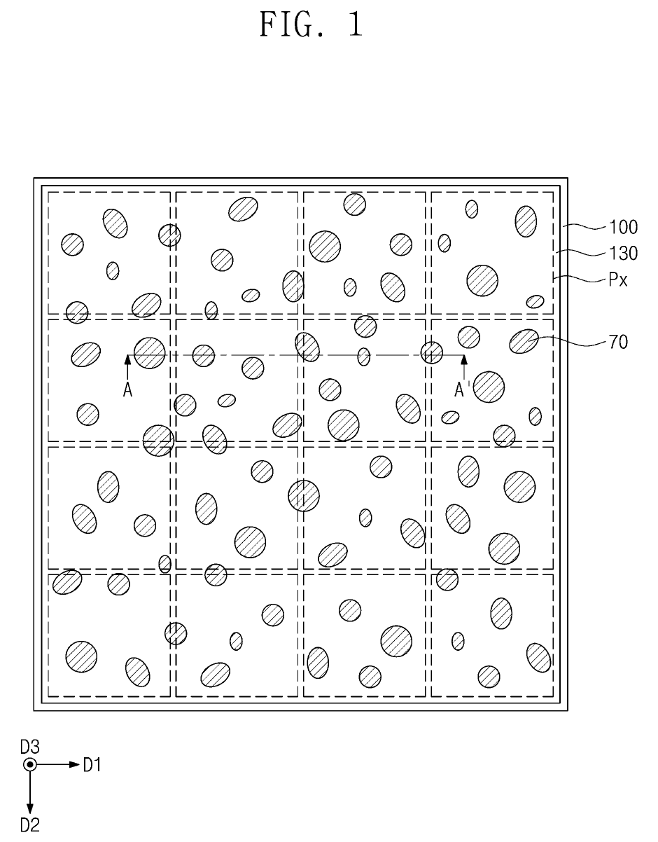

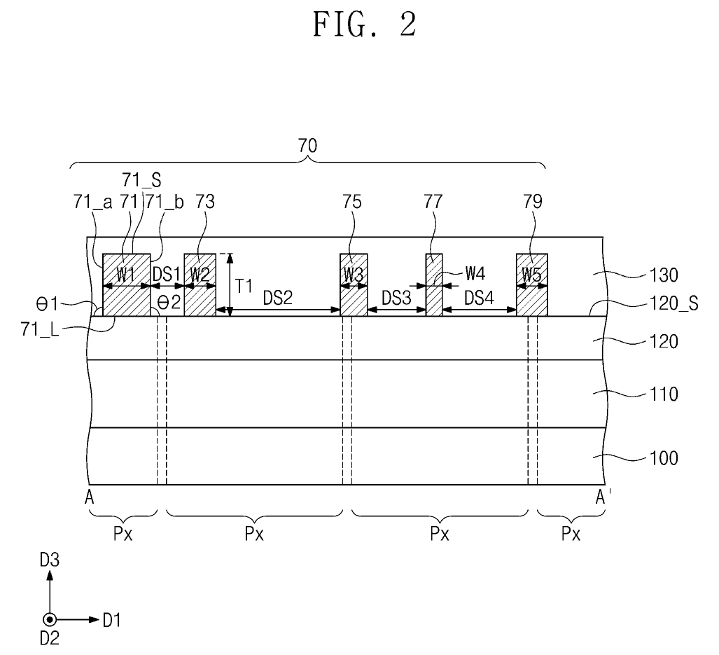

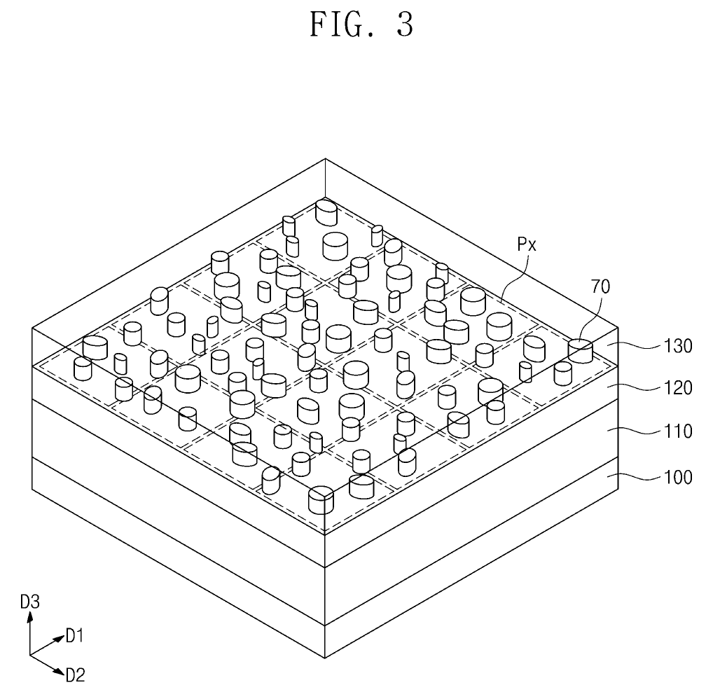

FIG. 1 is a plan view of an optical device according to embodiments of the inventive concept. FIG. 2 is a cross-sectional view cut along line A-A’ of FIG. 1 according to embodiments of the inventive concept. FIG. 3 is a perspective view of an optical device according to embodiments of the inventive concept.

Referring to FIGS. 1, 2, and 3, the optical device according to embodiments of the inventive concept may include a meta-structure that emits light in the visible region. The optical device may include a substrate 100, a metal layer 110, an insulation layer 120, nanopatterns 70, and a medium layer 130.

The substrate 100 may include a plurality of pixel regions Px. The pixel regions Px may be spaced apart from each other along first and second directions D1 and D2 parallel to the substrate 100. The substrate 100 may include, for example, at least one of glass, plastic, metal foil, a polymer, Si, ZnO, GaAs, SiC, MgAl₂O₄, MgO, LiAlO₂, LiGaO₂, or GaN, or a combination thereof. By way of an example, the substrate 100 may be a silicon single crystal substrate.

The metal layer 110 may be disposed on the substrate 100. The metal layer 110 may include, for example, at least one of aluminum (Al), molybdenum (Mo), gold (Au), silver (Ag), copper (Cu), tungsten (W), or indium tin oxide (ITO). The metal layer 110 may include electrodes.

The insulation layer 120 may be disposed on the metal layer 110. The insulation layer 120 may include, for example, silicon oxide or silicon nitride. Alternatively, the insulation layer 120 may include a dielectric, for example, SiO₂, MgF₂, Al₂O₃, or HfO₂.

The nanopatterns 70 may be disposed on the insulation layer 120. The nanopatterns 70 may be nano-scale structures such as nanorods, nanopillars, or nanowires. In a plan view, the nanopatterns 70 may be randomly disposed so that the distances and directions between the nanopatterns 70 are randomized in a direction parallel to the insulation layer 120, and the size and shape of the nanopatterns 70 may be different from each other. The cross sections of the nanopatterns 70 may have planar circular or planar elliptical shapes. However, unlike the shown example, the cross sections of the nanopatterns 70 may have planar triangular or planar rectangular shapes.

The nanopatterns 70 may include materials that are not absorbed in the visible region and have less change in refractive index. The nanopatterns 70 may include, for example, an inorganic insulation layer of silicon nitride, aluminum oxide, titanium oxide, or the like, a high-refractive index semiconductor of a semiconductor oxide, a semiconductor nitride, or the like, or a high-refractive index organic layer. For example, the nanopatterns 70 may include a metal of gold (Au), silver (Ag), aluminum (Al), titanium (Ti), molybdenum (Mo), or the like.

The medium layer 130 may cover a top surface 120_Sof the insulation layer 120 and the nanopatterns 70. The medium layer 130 may include, for example, at least one of a polymer, a dielectric, glass or an air cavity. The medium layer 13 may include, for example, a silicon oxide layer or an inorganic layer having a lower permittivity than the nanopatterns 70.

Hereinafter, the nanopatterns 70 will be described in more detail.

Referring to FIG. 2, the nanopatterns 70 may include first to fifth nanopatterns 71, 73, 75, 77, and 79. The first to fifth nanopatterns 71, 73, 75, 77, and 79 may have first to fifth different widths W1, W2, W3, W4, and W5 in the first direction D1, respectively. The first to fifth nanopatterns 71, 73, 75, 77, and 79 may have the same first thickness T1 in a third direction D3 vertical to the substrate 100. The aspect ratio of each of the first to fifth nanopatterns 71, 73, 75, 77, and 79 may be about 2 to about 10. Preferably, the aspect ratio of each of the first to fifth nanopatterns 71, 73, 75, 77, and 79 may be about 3 to about 10.

In the first direction D1, a first distance DS1 between the first nanopattern 71 and the second nanopattern 73, a second distance DS2 between the second nanopattern 73 and the third nanopattern 75, a third distance DS3 between the third nanopattern 75 and the fourth nanopattern 77, and a fourth distance DS4 between the fourth nanopattern 77 and the fifth nanopattern 79 may be different from each other. For example, the second distance DS2 may be larger than the first distance DS1. The third distance DS3 and the fourth distance DS4 may be smaller than the second distance DS2.

The first nanopattern 71 may include a first side wall 71_a and a second side wall 71_b facing each other in the first direction D1. The first side wall 71_a may form a first angle θ1 with the top surface 120_S of the insulation layer 120, and the second side wall 71_b may form a second angle θ2 with the top surface 120_S of the insulation layer 120. Each of the first angle θ1 and the second angle θ2 may be a right angle. Namely, the nanopatterns 70 may be arranged vertically to the top surface 120_S of the insulation layer 120.

The nanopatterns 70 are randomly arranged to prevent generation of resonance at a specific wavelength. In particular, in case of an OLED device that has to emit various colors, generation of a distortion (in color, color sense, or aspect ratio, or the like) due to resonance may be prevented. Even when the nanopatterns 70 are randomly arranged, the nanopatterns 70 may be arranged at a right angle and/or at an angle close to the right angle with the top surface 120_S of the insulation layer 120 and have high aspect ratios. Accordingly, since the difference in refractive index still exists in a vertical and/or horizontal direction, the directionality of the emitted light may be enhanced. Thereby, an optical device may be provided which has the directionality at wavelengths of the visible region and improved light emission characteristics while suppressing the generation of resonance. When the light emission characteristics of the optical device are improved, efficiency may increase, power consumption may be reduced, and the lifetime of the optical device may be enhanced.

At least one of the nanopatterns 70 (for example, the fifth nanopattern 79) may overlap each of two neighboring pixel regions Px. Namely, the nanopatterns 70 may be freely arranged on the insulation layer 120 regardless of the pixel regions Px of the substrate 100. This is because, by randomly arranging the sizes, positions, and directions of the nanopatterns 70, generation of resonance may be reduced, and the light emitted from the optical device may have the directionality at wavelengths of the visible region.

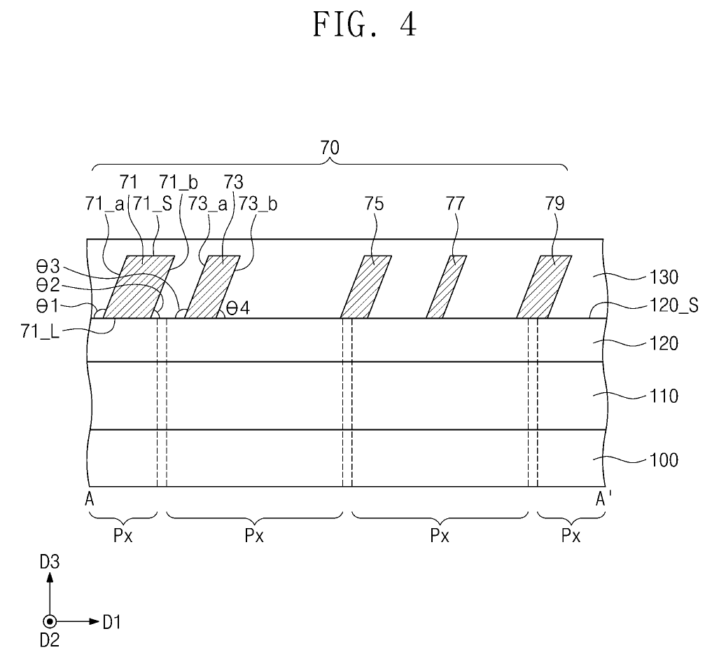

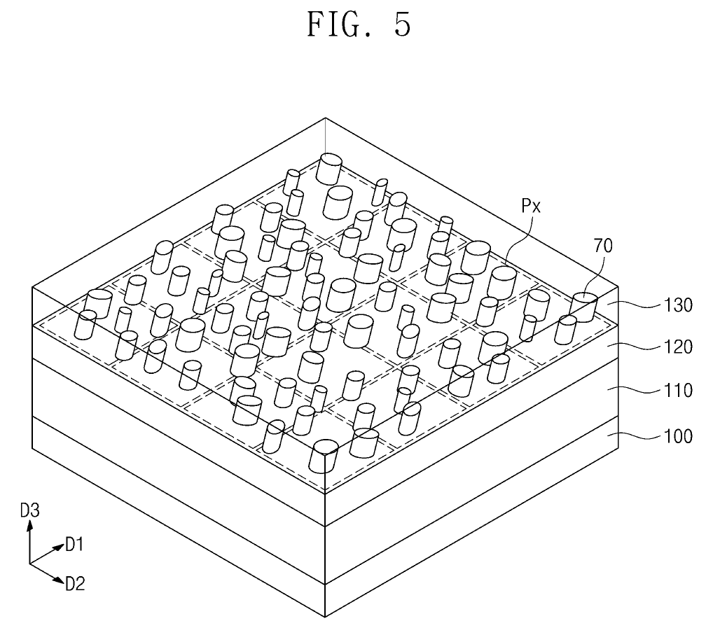

FIG. 4 is a cross-sectional view cut along line A-A’ of FIG. 1 according to embodiments of the inventive concept. FIG. 5 is a perspective view of an optical device according to embodiments of the inventive concept.

Referring to FIGS. 4 and 5, the first nanopattern 71 according to an embodiment may include the first side wall 71_a and the second side wall 71_b facing each other in the first direction D1. The first side wall 71_a may form a first angle θ1 with the top surface 120_S of the insulation layer 120, and the second side wall 71_b may form a second angle θ2 with the top surface 120_S of the insulation layer 120. The first angle θ1 may be an obtuse angle and the second angle θ2 may be an acute angle. The nanopatterns 71 may be tilted to the top surface 120_S of the insulation layer 120. Namely, a center of a top surface 71_S and a center of a bottom surface 71_L of the first nanopattern 71 may be offset in the first direction D1.

The second nanopattern 73 may include a third side wall 73_a and a fourth side wall 73_b facing each other in the first direction D1. The third side wall 73_a may form a third angle θ3 with the top surface 120_S of the insulation layer 120, and the fourth side wall 73_b may form a fourth angle θ4 with the top surface 120_S of the insulation layer 120. The third angle θ3 may be the same as the first angle θ1, and the fourth angle θ4 may be the same as the second angle θ2. Namely, the third angle θ3 may be the obtuse angle and the fourth angle θ4 may be the acute angle.

The nanopatterns 70 may be not vertical, but tilted to the top surface 120_S of the insulation layer 120. Namely, the center of the top surface and the center of the bottom surface of at least one of the nanopatterns 70 may be offset in the first direction D1. Thereby, light may be emitted in a desired specific direction without being limited to the vertical direction. Other components may be the same/similar to those described with reference to FIGS. 1 to 3.

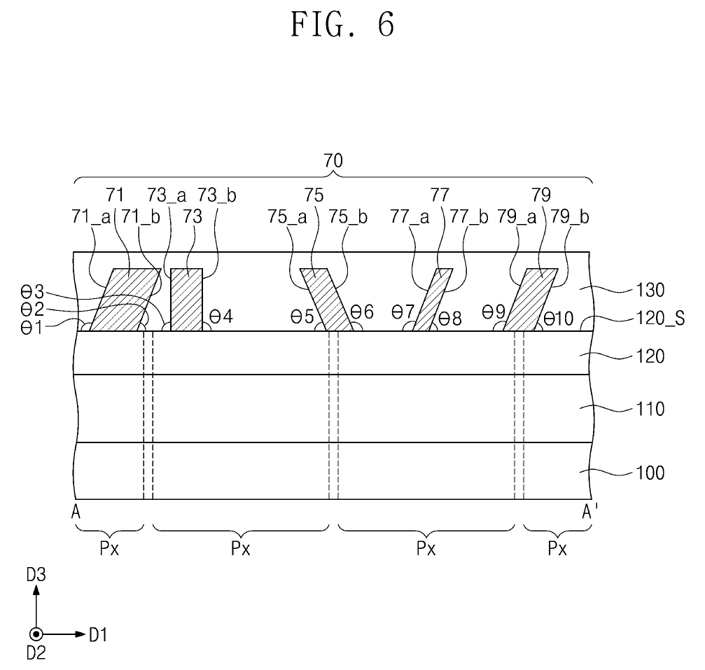

FIG. 6 is a cross-sectional view cut along line A-A’ of FIG. 1 according to embodiments of the inventive concept.

Referring to FIG. 6, in the optical device according to an embodiment, the third angle θ3 and the fourth angle θ4 are right angles with the top surface 120_S of the insulation layer 120 in the structure of FIG. 4.

The third nanopattern 75 may include a fifth side wall 75_a and a sixth side wall 85_b facing to each other in the first direction D1. The fifth side wall 75_a may form a fifth angle θ5 with the top surface 120_S of the insulation layer 120, and the sixth side wall 75_b may form a sixth angle θ6 with the top surface 120_S of the insulation layer 120. The fifth angle θ5 may be an acute angle and the sixth angle θ6 may be an obtuse angle.

The fourth nanopattern 77 may include a seventh side wall 77_a and an eighth side wall 77_b facing each other in the first direction D1. The seventh side wall 77_a may form a seventh angle θ7 with the top surface 120_S of the insulation layer 120, and the eighth side wall 77_b may form an eight angle θ8 with the top surface 120_S of the insulation layer 120. The seventh angle θ7 may be an obtuse angle and the eighth angle θ8 may be an acute angle.

The fifth nanopattern 79 may include a ninth side wall 79_a and a tenth side wall 79_b facing each other in the first direction D1. The ninth side wall 79_a may form a ninth angle θ9 with the top surface 120_S of the insulation layer 120, and the tenth side wall 79_b may form a tenth angle θ10 with the top surface 120_S of the insulation layer 120. The ninth angle θ9 may be an obtuse angle and the tenth angle θ10 may be an acute angle.

At least one of the nanopatterns 70 may be not vertical, but tilted to the top surface 120_S of the insulation layer 120. Angles between the top surface 120_S of the insulation layer 120 and the side walls of the nanopatterns 70 may be different from each other. Thereby, light may be emitted in desired specific directions without being limited to the vertical direction. Other components may be the same/similar to those described with reference to FIGS. 1 to 5.

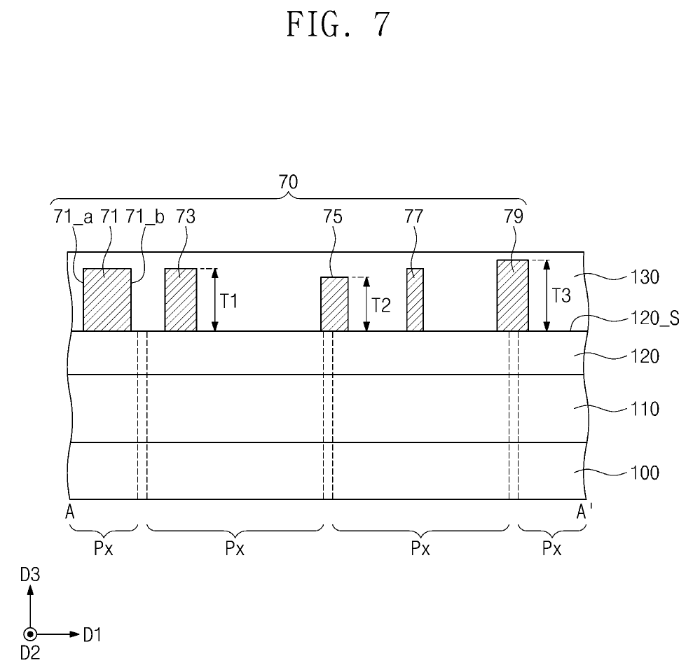

FIG. 7 is a cross-sectional view cut along line A-A’ of FIG. 1 according to embodiments of the inventive concept.

Referring to FIG. 7, the first nanopattern 71, the second nanopattern 73, and the fourth nanopattern 77 may have a first thickness T1 in the third direction D3 vertical to the substrate 100. The third nanopattern 75 may have a second thickness T2 smaller than the first thickness T1. The fifth thickness 79 may have a third thickness T3 larger than the first thickness T1. The thicknesses of the nanopatterns 70 are different from each other, and accordingly a refractive index of the light or an angle of emitted light due to the intensity may be differed . Other components may be the same/similar to those described with reference to FIGS. 1 to 5.

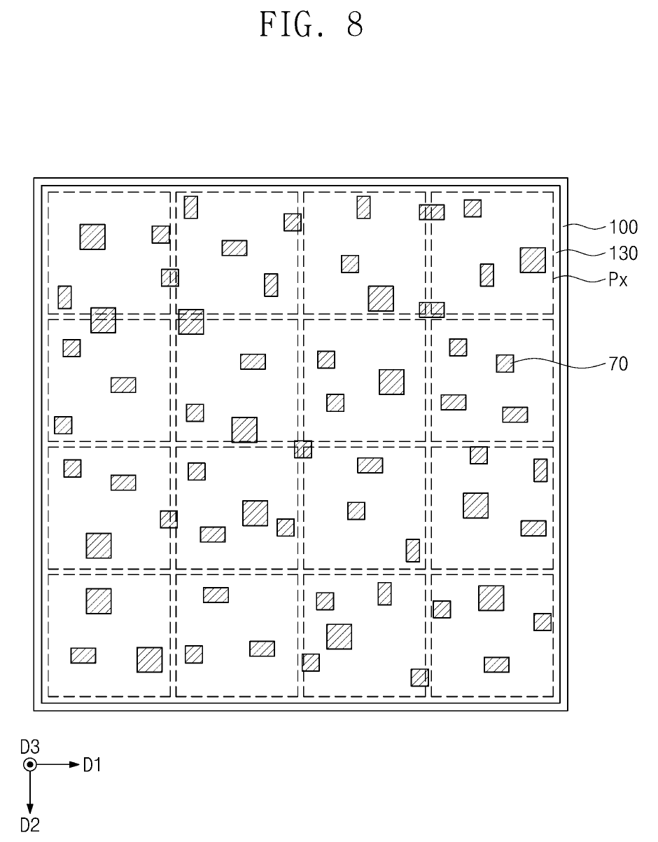

FIG. 8 is a plan view of an optical device according to embodiments of the inventive concept.

Referring to FIG. 8, according to an embodiment, the cross sections of the nanopatterns 70 may have planar square or planar rectangular shapes. Other components may be the same/similar to those described with reference to FIGS. 1 to 7.

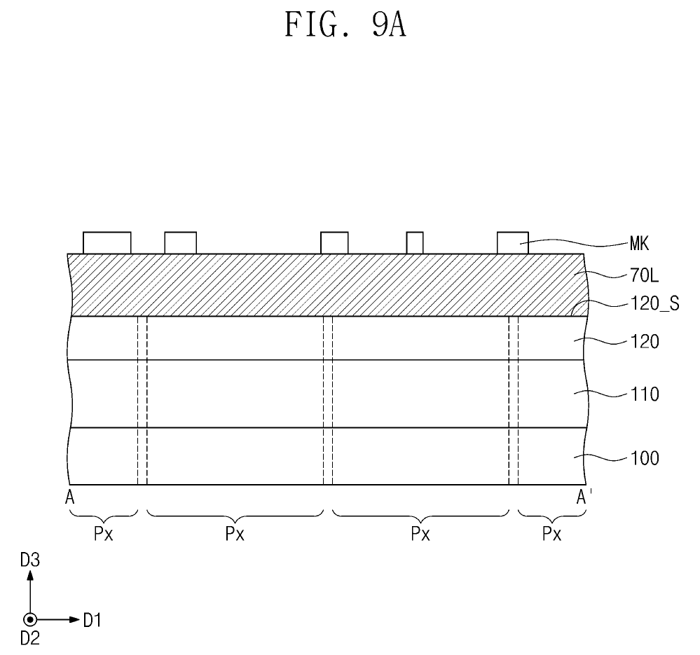

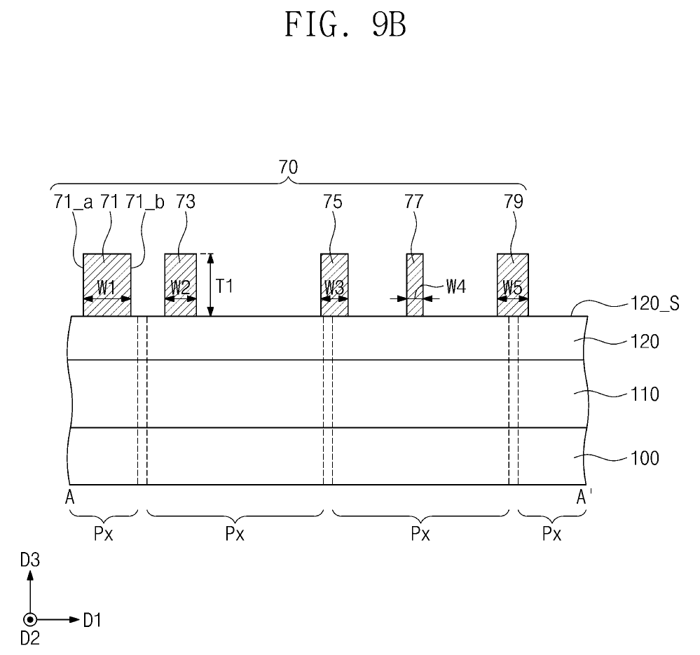

FIGS. 9A and 9B are cross-sectional views showing a process for manufacturing the optical device of FIG. 2.

Referring to FIG. 9A, the substrate 100, the metal layer 110, and the insulation layer 120 are sequentially provided, and then a nanopattern layer 70L may be provided on the top surface 120_S of the insulation layer 120. The nanopattern layer 70L may be provided using an atomic layer deposition (ALD) method or a chemical vapor deposition (CVD) method so that the nanopatterns 70 to be described below have high aspect ratios. Mask patterns MK may be disposed on the nanopattern layer 70L. The mask patterns ML may be photoresist.

Referring to FIGS. 2, 9A, and 9B, the mask patterns MK may be served as an etching mask to etch the nanopattern layer 70L, and then the mask patterns MK may be removed to provide the plurality of nanopatterns 70. The nanopatterns 70 may include the first to fifth nanopatterns 71, 73, 75, 77, and 79 of FIG. 2. The first to fifth nanopatterns 71, 73, 75, 77, and 79 may have first to fifth different widths W1, W2, W3, W4, and W5, respectively. A process for providing the nanopattern layer 70L may include, for example at least one of photolithography, nano-imprint lithography (NIL), or electron beam lithography. In FIG. 9B, an etching process using photolithography is shown. Then the medium layer 130 covering the insulation layer 120 and the nanopatterns 70 is provided to provide the optical device of FIG. 2.

In the optical device according to the inventive concept, the sizes of nanopatterns on the substrate, and the distances and directions between the nanopatterns are randomly arranged, and thus light emitted from the optical device may have directionality at wavelengths in the visible region. Thereby, the light-emission characteristics of the optical device may be improved.

Although the embodiments of the present invention have been described above with reference to the accompanying drawings, the present invention may be implemented without changing the technical spirit or essential features thereof. Therefore, the embodiments as described above are only proposed for illustrative purposes and do not limit the present disclosure.

What is claimed is:

1. An optical device comprising:
an insulation layer;
a plurality of nanopatterns disposed on the insulation layer and spaced apart from each other on the insulation layer; and
a medium layer covering the nanopatterns, wherein
the nanopatterns comprise first to third nanopatterns,
the first to third nanopatterns respectively comprise first to third different widths in a first direction parallel to a top surface of the insulation layer, and
a first distance between the first nanopattern and the second nanopattern is different from a second distance between the second nanopattern and the third nanopattern.

2. The optical device of claim 1, wherein
in a plan view, distances and directions of the nanopatterns are randomly arranged in a direction parallel to the top surface of the insulation layer.

3. The optical device of claim 1, wherein
the nanopatterns have the same thickness in a direction vertical to the top surface of the insulation layer, and
aspect ratios of the nanopatterns are about 3 to about 10.

4. The optical device of claim 1, wherein
cross sections of the nanopatterns have planar circular or planar elliptical shapes.

5. The optical device of claim 1, wherein
the nanopatterns comprise at least one of a metal comprising gold, silver, aluminum, titanium, or the like, semiconductor oxide, or semiconductor nitride.

6. The optical device of claim 1, wherein
the first nanopattern comprises a first sidewall and a second sidewall facing each other in the first direction, wherein
the first side wall forms a first angle with the top surface of the insulation layer,
the second side wall forms a second angle with the top surface of the insulation layer,
the first angle is an obtuse angle, and the second angle is an acute angle.

7. The optical device of claim 6, wherein
the second nanopattern comprises a third sidewall and a fourth sidewall facing each other in the first direction, wherein
the third side wall forms a third angle with the top surface of the insulation layer,
the fourth side wall forms a fourth angle with the top surface of the insulation layer,
the third angle is the same as the first angle, and
the fourth angle is the same as the second angle.

8. The optical device of claim 6, wherein
the second nanopattern comprises a third sidewall and a fourth sidewall facing each other in the first direction, wherein
the third side wall forms a third angle with the top surface of the insulation layer,
the fourth side wall forms a fourth angle with the top surface of the insulation layer, and
the third and fourth angles are right angles, and wherein
the third nanopattern comprises a fifth sidewall and a sixth sidewall facing each other in the first direction, wherein
the fifth side wall forms a fifth angle with the top surface of the insulation layer,
the sixth side wall forms a sixth angle with the top surface of the insulation layer,
the fifth angle is an acute angle, and the sixth angle is an obtuse angle.

9. The optical device of claim 1, wherein
the first nanopattern has a first thickness in a direction vertical to the top surface of the insulation layer,
the second nanopattern has a second thickness smaller than the first thickness, and
the third nanopattern has a third thickness larger than the first thickness.

10. The optical device of claim 1, wherein
the medium layer comprises at least one of a polymer, a dielectric, glass, or an air cavity.

11. An optical device comprising:
an insulation layer;
a plurality of nanopatterns arranged on the insulation layer and spaced apart from each other on the insulation layer; and
a medium layer covering the nanopatterns, wherein
the nanopatterns comprise first to third nanopatterns, and
the first nanopattern comprises a first sidewall and a second sidewall facing each other in a first direction parallel to a top surface of the insulation layer, wherein
the first side wall forms a first angle with the top surface of the insulation layer,
the second side wall forms a second angle with the top surface of the insulation layer,
the first angle is an obtuse angle, and the second angle is an acute angle.

12. The optical device of claim 11, wherein
the second nanopattern comprises a third sidewall and a fourth sidewall facing each other in the first direction, wherein
the third side wall forms a third angle with the top surface of the insulation layer,
the fourth side wall forms a fourth angle with the top surface of the insulation layer,
the third angle is the same as the first angle, or is a right angle, and
the fourth angle is the same as the second angle, or is a right angle.

13. The optical device of claim 12, wherein
the third nanopattern comprises a fifth sidewall and a sixth sidewall facing each other in the first direction, wherein
the fifth side wall forms a fifth angle with the top surface of the insulation layer,
the sixth side wall forms a sixth angle with the top surface of the insulation layer,
the fifth angle is an acute angle, and the sixth angle is an obtuse angle.

14. The optical device of claim 11, wherein
cross sections of the nanopatterns have planar circular, planar elliptical, planar triangular, or planar rectangular shapes.

15. The optical device of claim 11, wherein
a first distance between the first nanopattern and the second nanopattern is different from a second distance between the second nanopattern and the third nanopattern.

16. The optical device of claim 11, wherein
the first to third nanopatterns respectively comprise first to third different widths in the first direction.

17. The optical device of claim 11, further comprising
a substrate under the insulation layer, wherein
the substrate comprises a plurality of pixel areas, and
at least one of the nanopatterns overlaps each of two neighboring pixel areas.

18. An optical device comprising:
a substrate comprising a plurality of pixel areas;
a metal layer on the substrate;
an insulation layer on the metal layer;
a plurality of nanopatterns arranged on the insulation layer and spaced apart from each other on the insulation layer; and
a medium layer covering the nanopatterns, wherein
at least one of the nanopatterns overlaps each of two neighboring pixel areas, and
aspect ratios of the nanopatterns are about 3 to about 10.

19. The optical device of claim 18, wherein
a center of a top surface and a center of a bottom surface of at least one of the nanopatterns are offset in a first direction parallel to a top surface of the insulation layer.

20. The optical device of claim 18, wherein
in a plan view, distances and directions between the nanopatterns are randomly arranged in a direction parallel to the substrate, and
the nanopatterns have different widths respectively in a first direction parallel to a top surface of the insulation layer.
